(19) United States
(12) Patent Application Publication
(10) Pub. No.: US 2026/0112124 A1
(43) Pub. Date: Apr. 23, 2026

(54) DIGITAL EFFECTS EXPERIENCE RENDERING SYSTEM

(71) Applicant: Snap Inc., Santa Monica, CA (US)

(72) Inventors: Willi Menapace, Los Angeles, CA (US); Robert Cornelius Murphy, Venice, CA (US); Aliasksandr Siarohin, Santa Monica, CA (US); Aleksei Stoliar, Los Angeles, CA (US); Sergey Tulyakov, Santa Monica, CA (US)

(21) Appl. No.: 18/920,550

(22) Filed: Oct. 18, 2024

(51) Int. Cl. G06T 19/00

(52) U.S. Cl. CPC G06T 19/006; G06T 2200/24

(57) ABSTRACT

Examples relate to systems and methods for generating digital effects experiences. The system performs operations including accessing a set of instructions that defines a digital effects experience. The system processes the set of instructions by a generative machine learning model to generate one or more digital effects comprising the digital effects experience. The system continuously processes one or more inputs, received by a user device, while the one or more digital effects comprising the digital effects experience are presented on the user device, along with the set of instructions in real time by the generative machine learning model to update presentation of the one or more digital effects comprising the digital effects experience.

### TECHNICAL FIELD

The present disclosure relates to computer graphics technologies, specifically to generative rendering engines for real-time digital effects on user devices.

### BACKGROUND

Some electronics-enabled devices, such as eyewear devices, allow users to interact with virtual content (e.g., augmented reality (AR) objects or other digital effects) while a user is engaged in some activity. The virtual content can be part of a digital effects application that presents such objects over a real-world environment. Current rendering engines for computer graphics rely on physics-based principles, requiring extensive 3D modeling, animation, and rigging, which is time-consuming and demands multiple experts. This traditional approach limits the ability to create highly realistic images and videos in real-time. Additionally, existing systems often require sophisticated tracking and recognition technology (which itself is imperfect), complicating the creation of realistic content.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of a digital effects experience generation system, according to some examples.

FIG. 6 illustrates a user interface of the digital effects experience generation system, according to some examples.

FIG. 7 is a flowchart illustrating a routine (e.g., a method or process), according to some examples.

FIG. 8 is a flowchart illustrating a routine (e.g., a method or process), according to some examples.

FIG. 9 illustrates a system including the head-wearable apparatus, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Current rendering engines heavily rely on physics-based principles that present substantial challenges in modern applications. These traditional approaches necessitate extensive 3D modeling, animation, and rigging processes, making the creation of realistic images and videos both time-consuming and resource-intensive. The complexity of this workflow requires the involvement of multiple experts working in parallel, including 3D modelers, animators, lighting specialists, and rendering engineers. This collaborative effort, while capable of producing high-quality results, is inherently inefficient for real-time applications and significantly limits accessibility for creators without specialized skills.

Furthermore, the current paradigm often depends on sophisticated tracking and recognition technology to accurately place objects within scenes or create augmented reality (AR) experiences. This reliance adds another layer of complexity to the content creation process, requiring additional expertise in computer vision and spatial computing. The need for such advanced technology further restricts the ability to quickly and easily generate realistic graphics across various environments and use cases. The limitations of existing techniques become particularly apparent when considering the growing demand for real-time, interactive, and personalized content. Traditional rendering engines struggle to adapt to user preferences and environments without extensive setup and pre-rendering, creating a bottleneck in the production of high-quality, responsive computer graphics. This inefficiency is especially problematic in emerging fields such as augmented reality, real-time gaming, and interactive storytelling, where the ability to generate and modify content on-the-fly is crucial.

Moreover, the current approach to computer graphics creation is not only time-consuming but also resource-intensive in terms of computational power and storage. The need for high-performance hardware to run complex physics simulations and render intricate 3D models limits the accessibility of advanced graphics capabilities, particularly on mobile devices and in real-time scenarios. This constraint hinders the widespread adoption of immersive and interactive graphical experiences across various platforms and user demographics. As a result of these challenges, there is a growing need for more efficient and accessible methods of generating realistic images and videos that can adapt to user preferences and environments without the extensive setup by traditional rendering engines.

The disclosed examples improve the efficiency of using the electronic device by providing an AR device (e.g., an eyewear device or head-wearable apparatus or mobile device) that allows users to seamlessly engage in digital effects sessions and experiences, such as AR experiences. Specifically, the disclosed techniques leverage generative rendering engines (e.g., a generative machine learning model or generative video rendering engine) to create highly realistic images and videos in real-time on many devices, including AR devices. This approach allows for the seamless addition of animated objects to scenes without the need for traditional 3D modeling, animation, or rigging. Furthermore, these capabilities can be applied to any image, scene, or environment automatically, eliminating the requirement for sophisticated tracking and recognition technology.

By utilizing a real-time text-to-video model as the generative rendering engine, the disclosed techniques enable the creation of photorealistic effects and AR experiences with ease, efficiency, and speed. This allows users to interact with and modify their digital environments in real-time, enhancing the immersive nature of AR experiences without having to use complex rendering and tracking systems that consume a great deal of processing and battery resources.

Specifically, the disclosed techniques access a set of instructions that defines a digital effects experience. The disclosed techniques process the set of instructions by a generative machine learning model to generate one or more digital effects including the digital effects experience. The disclosed techniques continuously process one or more inputs, received by a user device, while the one or more digital effects including the digital effects experience are presented on the user device, along with the set of instructions in real time by the generative machine learning model to update presentation of the one or more digital effects including or that make up the digital effects experience.

The disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content presented on a video or image.

### Networked Computing Environment

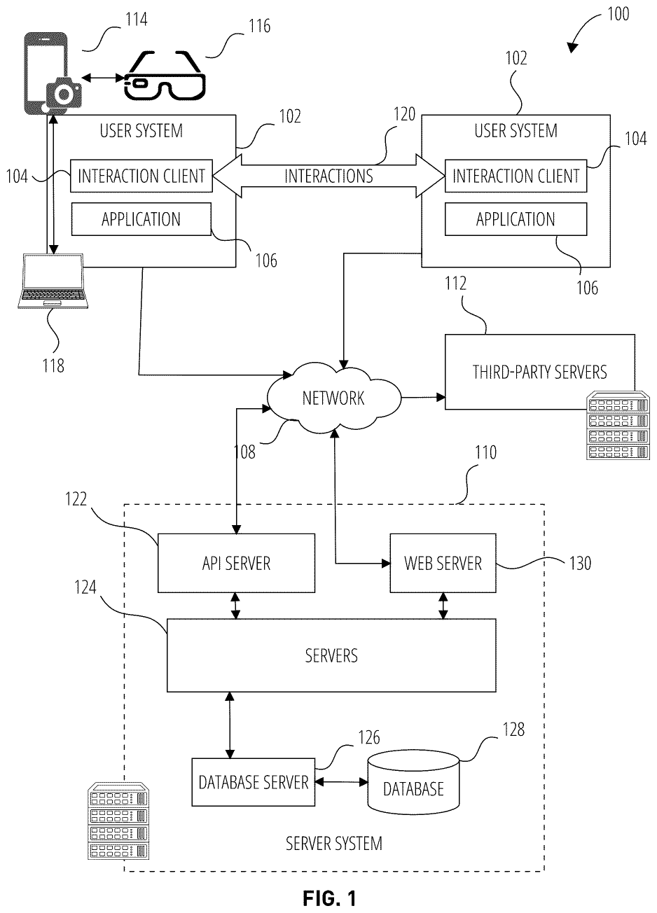

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

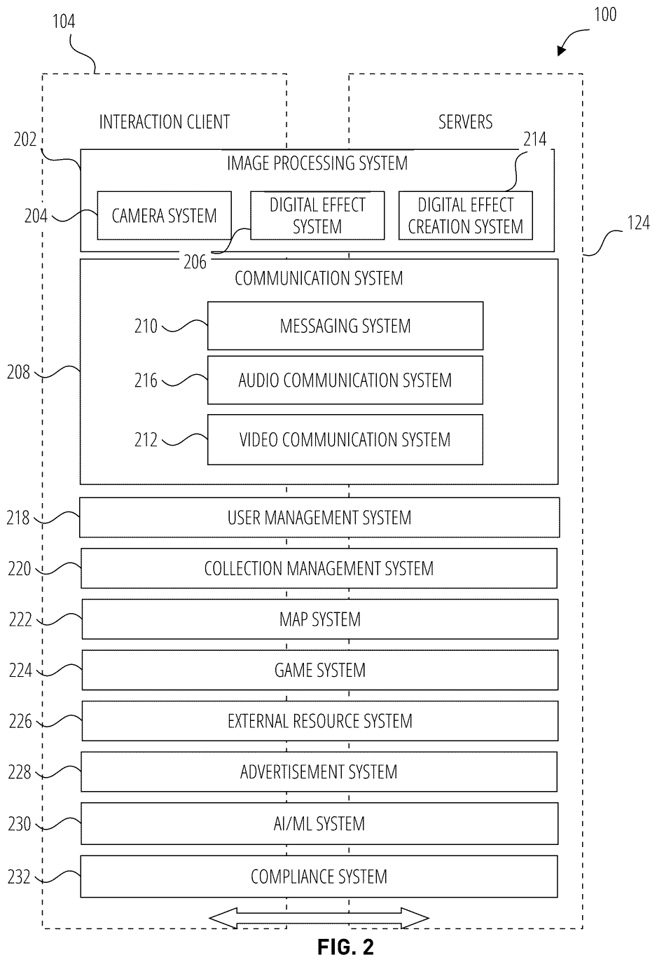

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116, as discussed below. In some examples, the external resources include instructions that define functionality to implement respective digital effects experiences. These instructions can include textual prompts that are processed by local or remote implementations of generative machine learning models to generate the digital effects experiences, such as by presented artificially generated or artificially augmented video with one or more digital effects.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 902 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100 including the digital effects experience generation system 504, such as the digital effects experience generation type selection component 516 and/or the SLAM based digital effects experience generation component 520.

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions. The artificial intelligence and machine learning system 230 can continuously process inputs as the artificial video is presented and update a display representing the digital effects experience in real time. This provides the perception to the user that information presented in the video is being tracked and modeled in real time without actually having to operation or user any tracking or modeling components of the user system 102.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

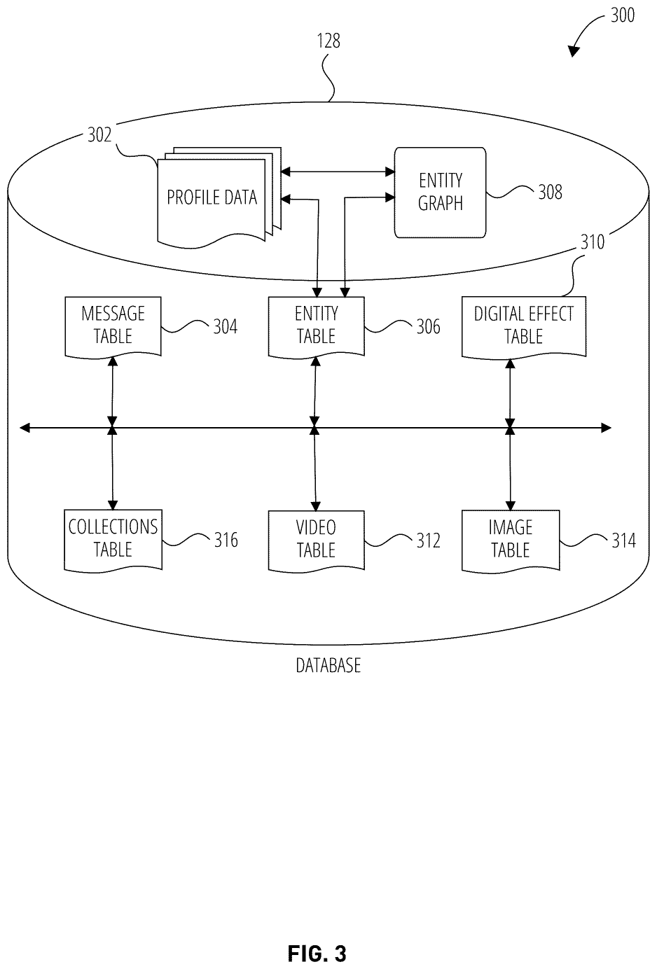

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by SLAM components or other tracking systems to provide outputs of the digital effects experiences.

### Data Communications Architecture

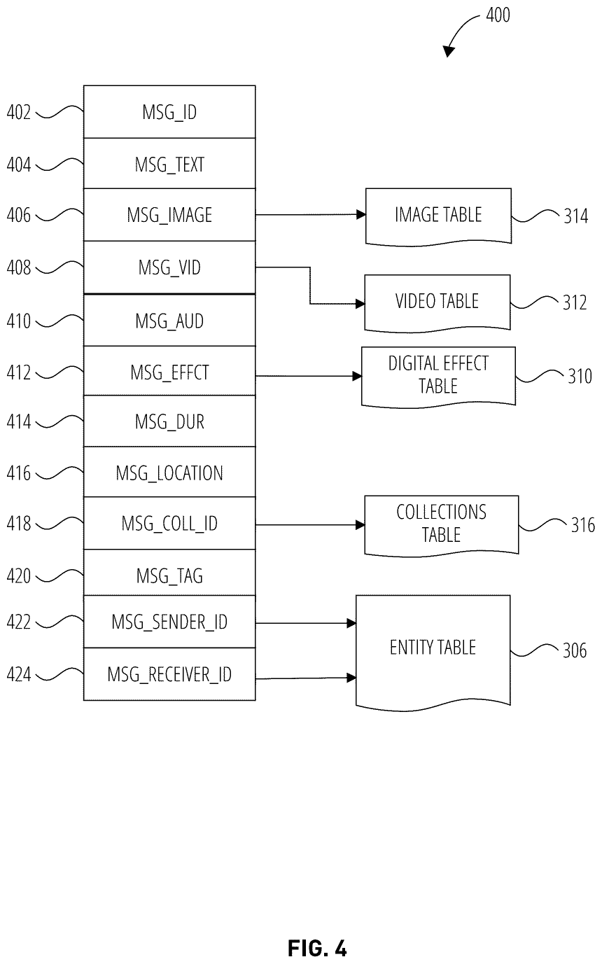

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

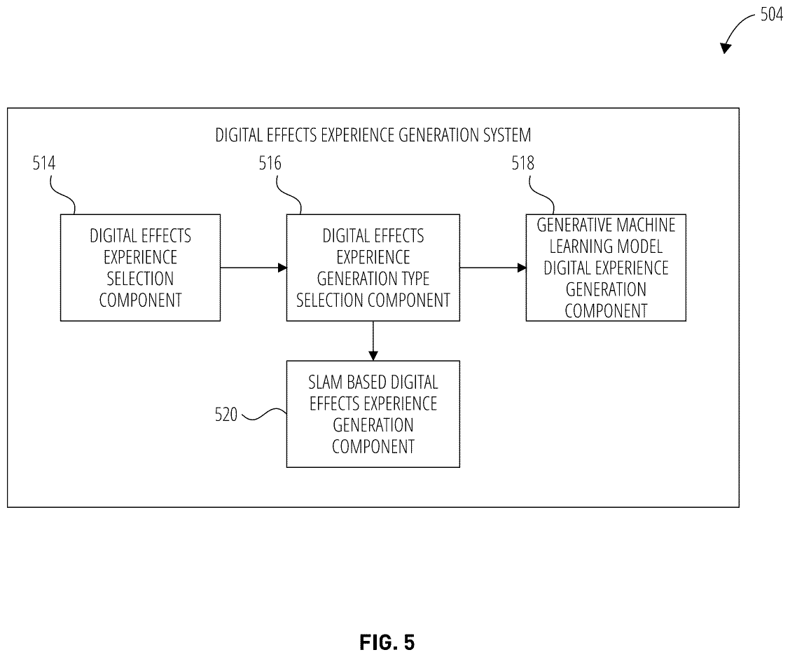

FIG. 5 illustrates a diagram of a digital effects experience generation system 504, according to some examples. The digital effects experience generation system 504 includes a digital effects experience selection component 514, a digital effects experience generation type selection component 516, a SLAM based digital effects experience generation component 520, and a generative machine learning model digital experience generation component 518.

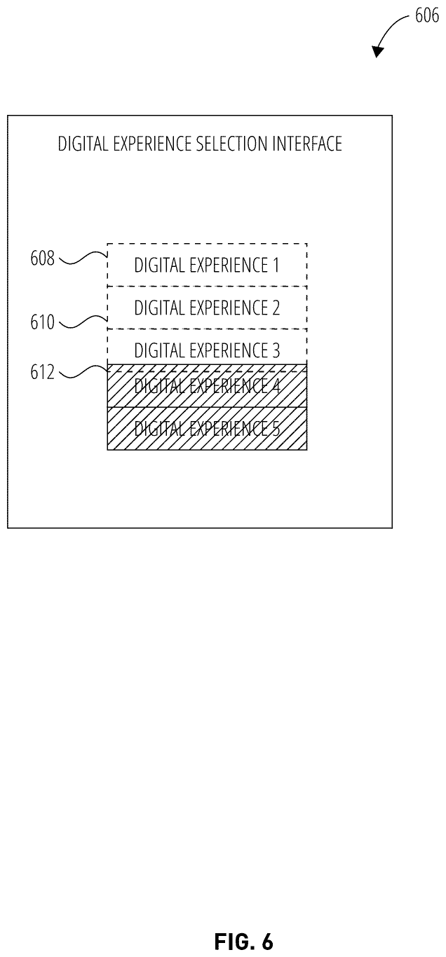

The digital effects experience selection component 514 can obtain a list of digital effects experiences available to a user system 102. The digital effects experience selection component 514 can present the list of digital effects, such as on a digital experience selection interface 606 shown in FIG. 6, on the user system 102. The digital experience selection interface 606 can present various icons or options for accessing different types of digital effects experiences. These icons or options can be overlaid on a video or image. In some cases, the icons or options can be presented in a separate user interface on a whole screen. In some cases, the digital experience selection interface 606 can receive input that includes a search criteria and the digital experience selection interface 606 can obtain the list of digital effects experiences that match the search criteria.

In some examples, the search criteria can specify digital effects experiences that operate with high efficiency and low hardware/software resources, and which consume a threshold amount of battery less than other digital effects experiences. Such experiences can be generated using only a generative machine learning model without any tracking or modeling components. In response, the digital experience selection interface 606 presents a list of icons or options 608 and 610 exclusively representing such digital effects experiences that are generated by the generative machine learning model without any tracking or modeling components. In some cases, the list of digital effects experiences can include a mix of high efficiency and low efficiency digital effects experiences. As referred to herein, “low efficiency” digital effects experiences are experiences generated and rendered by processing code and utilizing tracking and/or 3D modeling components, such as Simultaneous Localization and Mapping (SLAM) components. As referred to herein, “high efficiency” digital effects experiences are experiences generated and rendered by processing a set of instructions including prompts by a generative machine learning model that outputs a video representing defined behavior of the corresponding digital effects experience and without using the SLAM components. The icons or options 608 and 610 can be visually distinguished to indicate whether the corresponding digital effects experience represented by the icon/option is a high efficiency or low efficiency digital effects experience. For example, the high efficiency digital effects experiences can be represented by icons/options b 608 and 610 that are partially or entirely green or with a green background (and/or with some animation) whereas the low efficiency digital effects experiences can be represented by icons/options 612 that are partially or entirely red (and/or with static images).

The digital effects experience selection component 514 can receive input that selects a particular icon or option from the digital experience selection interface 606. The digital effects experience selection component 514 can provide the indication of the selected digital effects experience to the digital effects experience generation type selection component 516. The digital effects experience generation type selection component 516 can access data that defines operation of the selected digital effects experience. The data can be retrieved or accessed in the form or code (e.g., in the case of a low efficiency digital effects experience) or instructions including textual prompts that define behavior of the digital effects experience (e.g., in the case of a high efficiency digital effects experience).

The digital effects experience generation type selection component 516 can determine whether the data corresponding to the selected option of the digital effects experience is of a first type (e.g., including code associated with the low efficiency digital effects experience) or is of a second type (e.g., including instructions with textual prompts associated with the high efficiency digital effects experience). In response to the digital effects experience generation type selection component 516 determining that the selected option of the digital effects experience is of the first type (e.g., including code associated with the low efficiency digital effects experience), the digital effects experience generation type selection component 516 activates the SLAM based digital effects experience generation component 520 and process the data using the SLAM based digital effects experience generation component 520 to generate an output of the digital effects experience. In response to the digital effects experience generation type selection component 516 determining that the selected option of the digital effects experience is of the second type (e.g., including instructions with textual prompts associated with the high efficiency digital effects experience), the digital effects experience generation type selection component 516 activates the generative machine learning model digital experience generation component 518 and process the data using the generative machine learning model digital experience generation component 518 to generate an output (e.g., an artificial video with digital effects) of the digital effects experience.

In order to generate the digital effects experience using the data of the first type, the SLAM based digital effects experience generation component 520 can collect sensor data from the user system 102. The sensor data can include any type of motion sensor, such as a gyroscope and/or accelerometer. The image tracking component can generate SLAM information or data that enables the digital effect presentation system to perceive a real-world environment and generate accurately a 3D scene that includes the digital effects. SLAM uses a camera and image recognition software to identify surfaces, and then maps out a space while keeping track of the device's location within that space. This allows the digital effect application to identify objects and images in the real world and project virtual content onto the AR displays, creating immersive and realistic experiences.

To implement SLAM for digital effects experience generation, a combination of specialized hardware and software components may be required. The hardware components used for SLAM include various sensors such as a high-quality camera for capturing visual information about the surroundings, which can be either a standard RGB camera or a depth-sensing camera for more accurate 3D mapping. An Inertial Measurement Unit (IMU), including accelerometers and gyroscopes, can be used for measuring linear acceleration and angular velocity, providing data on the device's movement and orientation. Depending on the application, additional sensors like GPS, magnetometers, or barometers can enhance localization accuracy.

A powerful processor, such as a high-performance mobile processor or a dedicated AI chip, may handle the real-time computations used for SLAM. Sufficient RAM for storing and processing the large amounts of data generated during SLAM operations, while fast, high-capacity storage may be needed to save map data, feature points, and other SLAM-related information. For AR (digital effects) applications and/or experiences, a high-resolution, low-latency display is used for rendering the augmented content seamlessly.

On the software side, SLAM can utilize several key components. An image processing module handles tasks such as feature detection, descriptor extraction, and image enhancement to prepare visual data for SLAM processing. Feature tracking algorithms track distinctive features across multiple frames to estimate camera motion and build a map of the environment. Loop closure detection algorithms recognize when the device has returned to a previously visited location, allowing for map refinement and error correction. Map management software efficiently stores, updates, and retrieves map data, including 3D point clouds and feature descriptors. Pose estimation algorithms combine data from various sensors to accurately determine the device's position and orientation in real-time. Sensor fusion software integrates data from multiple sensors to improve localization accuracy and robustness. 3D reconstruction algorithms create detailed 3D models of the environment based on the collected sensor data.

AR content rendering software can generate and overlay digital effects onto the real-world view, taking into account the device's position and orientation. Optimization algorithms, such as bundle adjustment or graph optimization, refine map and trajectory estimates.

Additionally, machine learning models may be incorporated for improved feature detection, object recognition, or scene understanding. The integration of these hardware and software components may be optimized for real-time performance, energy efficiency, and accuracy to provide a seamless AR experience. The software architecture can be designed to handle varying environmental conditions, dynamic scenes, and potential sensor errors or failures. By leveraging these components, the SLAM based digital effects experience generation component 520 can create immersive AR applications, allowing for accurate tracking of the device's position and orientation within the environment, and enabling the seamless integration of digital effects into the real world. The SLAM based digital effects experience generation component 520 can capture or receive a live or real time video and present one or more digital effects as overlays on specified portions of the video. The SLAM based digital effects experience generation component 520 can track positions of real-world or virtual objects in the video and can update the displayed digital effects based on changes to the tracked positions.

The generative machine learning model digital experience generation component 518 can receive the data of the second type and process such data by a generative machine learning model to render an artificial video corresponding to the selected digital effects experience. The artificial video can be presented on a display of the user system 102. The generative machine learning model digital experience generation component 518 can monitor user interactions and/or can receive a video in real time from a camera of the user system 102. The generative machine learning model digital experience generation component 518 can continuously process the user interactions and the video together with the set of instructions or prompts of the data to continuously rendering additional artificial frames of the video. The additional frames can represent updated positions and behavior of digital effects that are presented by prior artificial frames generated by the generative machine learning model digital experience generation component 518. This provides the illusion to the user that the user system 102 is tracking a position of objects (real or virtual) presented in the video without actually using any SLAM components.

Namely, the generative machine learning model digital experience generation component 518 continuously updates artificial frames of the artificial video to account for interactions and movement of the user system 102 (as perceived by the generative machine learning model digital experience generation component 518 in updated frames captured by the camera). The artificial frames can be rendered to look like the real frames captured by the camera of the user system 102 but may not be the actually captured frames. The artificial frames represent both the content of the real frames captured by the camera and the digital effects that are defined by the prompt to be generated by the generative machine learning model.

The generative machine learning model digital experience generation component 518 leverages advanced AI techniques to create immersive digital effects experiences without relying on traditional SLAM (Simultaneous Localization and Mapping) components (or similar computer vision techniques, such as tracking, 3D reconstruction, depth estimations, object detection, and other related techniques). This approach represents a significant shift in how augmented reality (AR) and virtual reality (VR) content is generated and presented to users. At the core of the generative machine learning model digital experience generation component 518 is a real-time text-to-video generation model, which serves as the generative rendering engine. This model can process a set of instructions or prompts to generate highly realistic images and videos in real-time on most devices, including AR devices. The ability to create photorealistic effects and AR experiences with unprecedented ease and speed allows for a more dynamic and responsive user experience than that provided by the SLAM based digital effects experience generation component 520. One of the keys of this approach is the seamless addition of animated objects to scenes without the need for traditional 3D modeling (as well as without traditional graphical techniques such as light and normal estimation and physics-based rendering), animation, or rigging. This capability significantly reduces the time and expertise to create compelling AR experiences, making it more accessible to a broader range of creators and developers.

The generative machine learning model digital experience generation component 518 continuously processes user interactions and real-time video input from the device's camera, along with the set of instructions or prompts, to render additional artificial frames. These frames represent updated positions and behaviors of digital effects, creating the illusion of object tracking without using conventional SLAM techniques. This approach allows for more flexible and adaptable AR experiences that can respond quickly to changes in the user's environment or interactions. The generative machine learning model digital experience generation component 518 can be trained to understand and render content tailored to the user's preferences, appearance, and surroundings. This includes the ability to accurately represent the user, their friends, pets, and familiar objects, creating a more engaging and relevant AR experience.

By bypassing traditional graphics processing engines and relying on the generative model, the generative machine learning model digital experience generation component 518 can offer improved performance and efficiency, especially on mobile devices. This approach may allow for more complex and realistic AR experiences to be delivered on a wider range of hardware, expanding the potential user base for immersive digital content.

The generative machine learning model digital experience generation component 518 can access video captured by the device's camera, depicting a real-world environment. The generative model processes this video with the set of instructions to render a new video that includes the digital effects experience. This new video is then presented on the user device.

When the device detects movement, the system captures images of different portions of the environment. These images are processed with the instructions to generate additional video content, ensuring the experience remains dynamic and responsive.

User interactions with the digital effects are also detected and processed. The generative model uses these interactions, along with the instructions, to generate additional video content, maintaining an interactive and engaging experience. The inputs processed by the generative machine learning model digital experience generation component 518 can include audio, images, or physical movements, allowing for a rich and varied interaction with the digital effects. The instructions may include textual prompts that define scenes, describe effects, and specify their movement and positioning relative to real-world objects.

Real-world objects, such as body parts depicted in input images or videos, can be used as reference points for positioning digital effects. The textual prompts also define the interactivity of the experience, describing how the model should modify effects in response to user inputs. Goals associated with the digital effects experience can be included in the prompts, guiding the generative model in creating a coherent and purposeful experience. The prompts may also specify digital objects used as effects and conditions for their presentation. The digital effects experience is presented as a video, bypassing traditional graphics processing engines, which enhances performance and efficiency. The generative model is trained to generate video content based on these prompts, ensuring a seamless and immersive experience for the user.

The generative machine learning model digital experience generation component 518 can process a wide variety of prompts (as instructions of digital effects experiences) to create immersive and interactive digital effects experiences. For example, for a forest scene prompt, the generative machine learning model digital experience generation component 518 can generate a serene environment with dynamic lighting effects. The generative machine learning model digital experience generation component 518 monitors user gaze and device movement to control a floating orb's position, leaving behind particle trails. The generative machine learning model digital experience generation component 518 detects tap or gesture inputs to trigger the orb's transformation into butterflies, demonstrating real-time responsiveness to user interactions. In this case, the set of instructions can include a prompt specifying: “Generate a lush forest environment with dappled sunlight. Create a glowing orb that follows the user's gaze and leaves a trail of particles. When tapped, transform the orb into a swarm of colorful butterflies that disperse and fade.” For instance, in the forest scene example, the initial artificial video is generated to show a serene forest with a glowing orb. As the user's gaze moves, detected by the device's sensors, the generative machine learning model digital experience generation component 518 processes this input along with the original instructions to create new artificial frames showing the orb following the gaze and leaving a particle trail. When a tap is detected, the generative machine learning model digital experience generation component 518 generates frames depicting the orb transforming into butterflies.

In a futuristic cityscape scenario, the generative machine learning model digital experience generation component 518 can create a complex urban environment with animated elements like flying cars and holographic displays. The generative machine learning model digital experience generation component 518 processes voice commands to modify a user's 3D avatar appearance and uses facial recognition to animate the avatar in real-time, showcasing the system's ability to handle multiple input types simultaneously. In this case, the set of instructions can include a prompt specifying: “Create a cyberpunk city with flying vehicles and holographic signs. Place a 3D avatar of the user in the scene wearing customizable futuristic clothing. Allow voice commands to change the avatar's outfit and animate it to mimic the user's facial expressions.” Similar to before, in the futuristic cityscape scenario, the generative machine learning model digital experience generation component 518 continuously processes voice commands in real time and facial expressions along with the initial instructions. This results in new frames showing the avatar's outfit changing or its expressions mimicking the user's in real-time.

For an underwater scene, the generative machine learning model digital experience generation component 518 can produce a vibrant aquatic environment with physics-based water distortion effects. The generative machine learning model digital experience generation component 518 monitors device movement to simulate realistic water dynamics and detects hand proximity to trigger interactive elements like opening a treasure chest. This example demonstrates the system's capability to blend visual effects with spatial awareness. In this case, the set of instructions can include a prompt specifying: “Render an underwater world with coral reefs and fish schools. Apply water distortion effects based on device movement. Generate water ripples on swipe gestures. Add an interactive treasure chest that opens when the user's hand is nearby.” The initial artificial video would show a vibrant aquatic environment with coral reefs and schools of fish, as specified by the set of instructions. As device movement is detected, the generative machine learning model digital experience generation component 518 processes this data in real time with the original instructions to generate new artificial frames showing physics-based water distortion effects. When hand proximity to virtual objects is tracked, new artificial frames are generated showing interactive elements like a treasure chest opening. Any mention of frames generated by the generative machine learning model digital experience generation component 518 should be understood to mean artificial frames being generated using information in the instructions and/or a captured video.

In a space exploration experience, the generative machine learning model digital experience generation component 518 can transform the user's real environment into a virtual spacecraft interior. It maps real-world objects to virtual interfaces and uses device orientation data to update the view of space through virtual windows. The system can also process voice commands to interact with an AI character, illustrating its potential for educational applications. In this case, the set of instructions can include a prompt specifying: “Transform the user's room into a spacecraft interior. Map furniture to virtual control panels. Show a dynamic space view through windows based on device orientation. Include an alien character that responds to voice commands and explains space phenomena.” The initial artificial video would present the user's environment transformed into a virtual spacecraft interior with real-world objects mapped to virtual interfaces. As device orientation changes are detected, the generative machine learning model digital experience generation component 518 processes this data in real time along with the original instructions to create new artificial frames updating the view of space through virtual windows. When voice commands are recognized, the system generates additional frames showing the AI character responding and explaining space phenomena.

For a historical reenactment, the generative machine learning model digital experience generation component 518 can create a detailed ancient Roman setting. The generative machine learning model digital experience generation component 518 tracks user movement to populate the environment with interactive characters and uses object recognition to transform real items into period-accurate artifacts. This showcases the system's ability to blend real and virtual elements seamlessly. In this case, the set of instructions can include a prompt specifying: “Create an ancient Roman setting. Dress the user's 3D avatar in period clothing. Populate the space with interactive NPCs as the user moves. Transform real objects into Roman artifacts when pointed at with the device.” The initial artificial video would depict a detailed ancient Roman setting with the user's 3D avatar in period-appropriate clothing. As user movement is detected, the generative machine learning model digital experience generation component 518 processes this input in real time with the original instructions to generate new artificial frames populating the environment with interactive characters. When the device is pointed at real-world objects, the generative machine learning model digital experience generation component 518 creates additional frames showing these objects transformed into period-accurate artifacts.

In a music visualization experience, generative machine learning model digital experience generation component 518 can generate abstract 3D shapes that respond to audio input. The generative machine learning model digital experience generation component 518 detects hand gestures for user interaction and analyzes body movements to influence the visualization's color and intensity. This example demonstrates the system's capability to process and respond to multiple sensory inputs in real-time. In this case, the set of instructions can include a prompt specifying: “Generate abstract 3D shapes that react to the user's music. Allow hand gestures to interact with shapes. Adjust color scheme and intensity based on the user's dance movements. Synchronize visuals with beat and melody.” The initial artificial video would show abstract 3D shapes responding to audio input. As hand gestures are detected, the generative machine learning model digital experience generation component 518 processes these inputs in real time along with the original instructions to generate new artificial frames depicting the shapes changing based on the gestures. When body movements are analyzed, the generative machine learning model digital experience generation component 518 creates additional frames adjusting the overall color scheme and intensity of the visualization in real time.

For an interactive storybook experience, the generative machine learning model digital experience generation component 518 can transform the user's environment into a fairy tale setting. It uses real-world objects as anchors for virtual elements and processes voice input to allow user choices that affect the story and environment. This illustrates the system's potential for creating adaptive narrative experiences. In this case, the set of instructions can include a prompt specifying: “Turn the user's environment into a fairy tale setting. Use real objects as anchors for virtual characters and elements. Transform surroundings to match story progression. Implement voice recognition for user choices that affect the narrative.” The initial artificial video would present the user's environment transformed into a fairy tale setting with virtual characters and elements anchored to real-world objects. As user movement is detected, the generative machine learning model digital experience generation component 518 processes this data in real time with the original instructions to generate new artificial frames showing the environment changing to match different scenes. When voice input for story choices is recognized, the generative machine learning model digital experience generation component 518 creates additional frames depicting the story and environment adapting to the user's choices.

In a virtual art studio scenario, generative machine learning model digital experience generation component 518 can interpret hand gestures to allow users to create 3D sculptures. The generative machine learning model digital experience generation component 518 simulates realistic materials and lighting conditions, and can incorporate AI-generated suggestions, demonstrating the system's ability to blend user creativity with machine learning assistance. In this case, the set of instructions can include a prompt specifying: “Create a 3D sculpting environment where hand gestures form virtual clay. Apply realistic textures and lighting to sculptures. Allow resizing and repositioning of creations. Include an AI art assistant that offers tips and demonstrations.” The initial artificial video would show a 3D space where hand gestures can create virtual sculptures. As hand gestures are recognized, the generative machine learning model digital experience generation component 518 processes these inputs in real time along with the original instructions to generate new artificial frames showing 3D sculptures forming and changing, with realistic textures and lighting applied. The generative machine learning model digital experience generation component 518 also creates additional frames depicting an AI art assistant demonstrating techniques.

For a personalized fitness experience, the generative machine learning model digital experience generation component 518 can overlay a virtual trainer onto the user's environment. The generative machine learning model digital experience generation component 518 uses body tracking to analyze user form and generate adaptive virtual obstacles. The system also implements a gamification layer, showing its potential for creating engaging, goal-oriented experiences. In this case, the set of instructions can include a prompt specifying: “Overlay a virtual trainer in the user's space. Analyze body positioning for exercise form feedback. Generate adaptive virtual obstacles and targets. Implement a reward system where completed workouts unlock new environments and trainer customizations.” The initial artificial video would present the user's space with a virtual trainer overlaid and some initial virtual obstacles. As body movements are tracked, the generative machine learning model digital experience generation component 518 processes this data in real time with the original instructions to generate new artificial frames showing real-time feedback on exercise form and adaptive virtual obstacles appearing based on the user's performance. The generative machine learning model digital experience generation component 518 also creates additional frames depicting new environments or trainer customizations unlocking after completed workouts.

Lastly, in an educational biology experience, generative machine learning model digital experience generation component 518 can generate detailed visualizations of human anatomy based on where the user points their device. The generative machine learning model digital experience generation component 518 can create interactive quizzes and simulated tours inside the human body, adapting to user movement and gaze. This example showcases the system's potential for creating immersive educational content. In this case, the set of instructions can include a prompt specifying: “Transform the user's space into a biology learning environment. Show detailed organ visualizations when the device points at body parts. Create interactive anatomy quizzes with 3D models. Enable a virtual tour inside the human body that adapts to user movement and gaze.” The initial artificial video would show the user's space transformed into a biology learning environment. As the device's pointing direction is tracked, the generative machine learning model digital experience generation component 518 processes this input in real time along with the original instructions to generate new artificial frames showing detailed visualizations of internal organs when pointed at different body parts. During the virtual body tour, the generative machine learning model digital experience generation component 518 creates additional frames depicting the environment changing based on the user's movement and gaze direction.

These examples demonstrate the versatility of the generative machine learning model digital experience generation component 518, highlighting its ability to process various inputs, generate diverse digital effects, and respond to different conditions in real-time, all without relying on traditional SLAM or 3D modeling techniques.

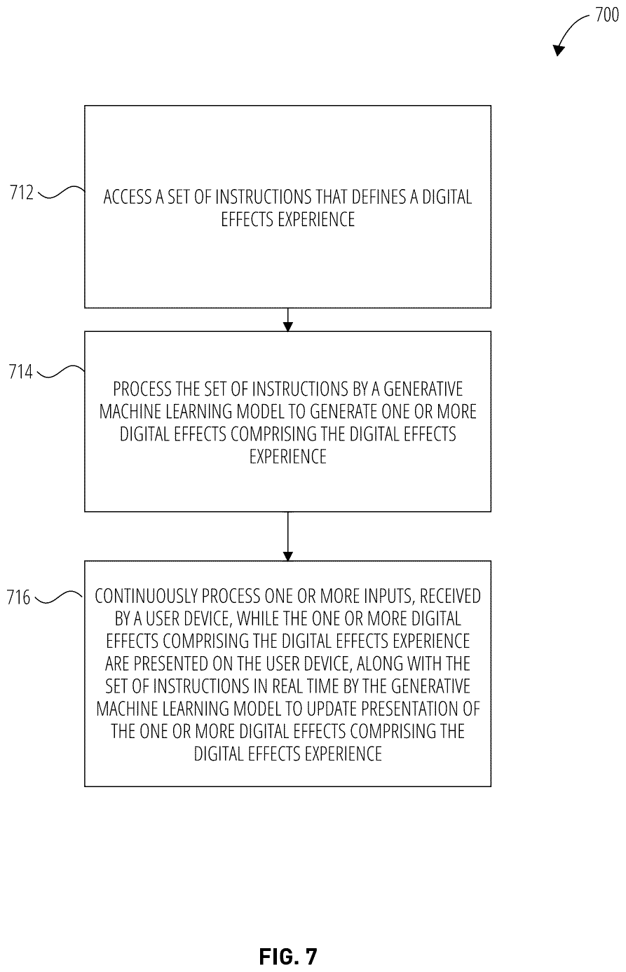

FIG. 7 is a flowchart illustrating routine 700 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 712, the digital effects experience generation system 504 accesses a set of instructions that defines a digital effects experience, as discussed above.

In operation 714, the digital effects experience generation system 504 processes the set of instructions by a generative machine learning model to generate one or more digital effects comprising the digital effects experience, as discussed above.

In operation 716, the digital effects experience generation system 504 continuously processes one or more inputs, received by a user device, while the one or more digital effects comprising the digital effects experience are presented on the user device, along with the set of instructions in real time by the generative machine learning model to update presentation of the one or more digital effects comprising the digital effects experience, as discussed above.

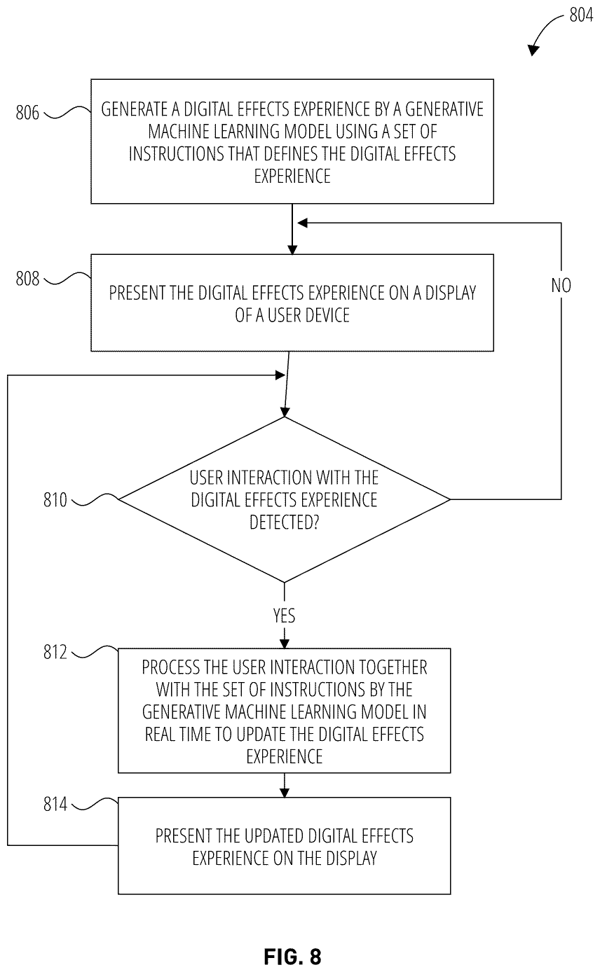

FIG. 8 is a flowchart illustrating a diagram 804 of a routine (e.g., a method or process), according to some examples. Although the example method depicted in FIG. 8 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 806, the digital effects experience generation system 504 generates a digital effects experience by a generative machine learning model using a set of instructions that defines the digital effects experience, as discussed above.

In operation 808, the digital effects experience generation system 504, presents the digital effects experience on a display of a user device, as discussed above.

In operation 810, the digital effects experience generation system 504 determines whether a user interaction with the digital effects experience is detected. If so, the digital effects experience generation system 504 performs operation 812. Otherwise, the digital effects experience generation system 504 performs operation 808.

In operation 812, the digital effects experience generation system 504 processes the user interaction together with the set of instructions by the generative machine learning model in real time to update the digital effects experience, as discussed above.

In operation 814, the digital effects experience generation system 504 presents the updated digital effects experience on the display, as discussed above.

### System With Head-Wearable Apparatus

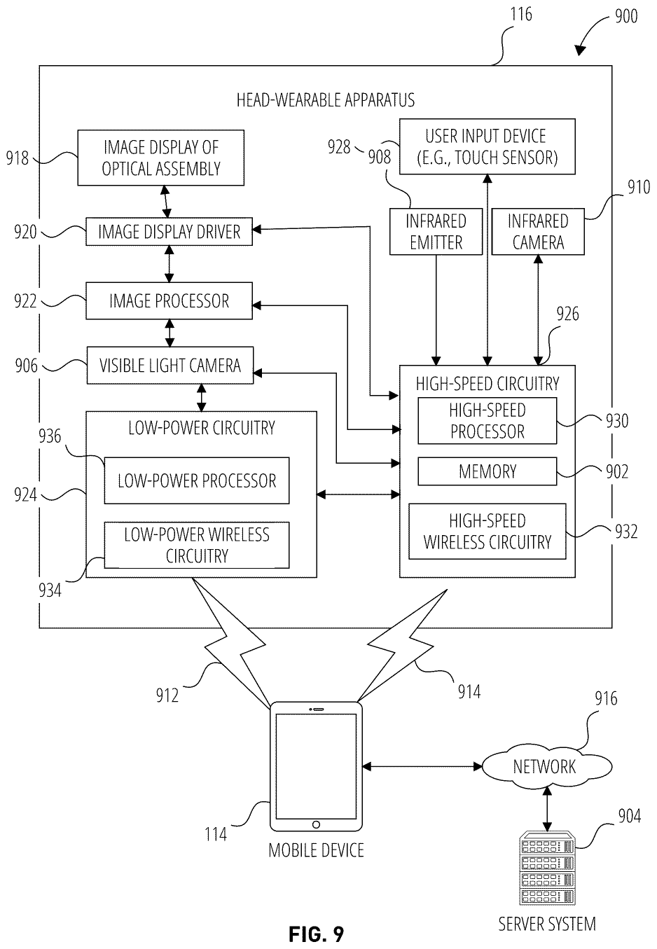

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110) via various networks.

The head-wearable apparatus 116 includes one or more cameras, each of which may be, for example, a visible light camera 906, an infrared emitter 908, and an infrared camera 910.

The mobile device 114 connects with head-wearable apparatus 116 using both a low-power wireless connection 912 and a high-speed wireless connection 914. The mobile device 114 is also connected to the server system 904 and the Network 916.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image Processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed Processor 930 to drive the left and right image displays of the image display of optical assembly 918. The high-speed Processor 930 may be any processor capable of managing high-speed communications and operation of any general computing system needed for the head-wearable apparatus 116. The high-speed Processor 930 includes processing resources needed for managing high-speed data transfers on a high-speed wireless connection 914 to a wireless local area network (WLAN) using the high-speed wireless circuitry 932. In certain examples, the high-speed Processor 930 executes an operating system such as a LINUX operating system or other such operating system of the head-wearable apparatus 116, and the operating system is stored in the memory 902 for execution. In addition to any other responsibilities, the high-speed Processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the Network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed Processor 930 from the image processor 922 or the low-power Processor 936 to the memory 902. In some examples, the high-speed processor 930 may manage addressing of the memory 902 such that the low-power processor 936 will boot the high-speed Processor 930 any time that a read or write operation involving memory 902 is needed.

As shown in FIG. 9, the low-power processor 936 or high-speed Processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a network communication interface coupled to the processor. The Network communication interface allows for communication over the Network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws.

Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

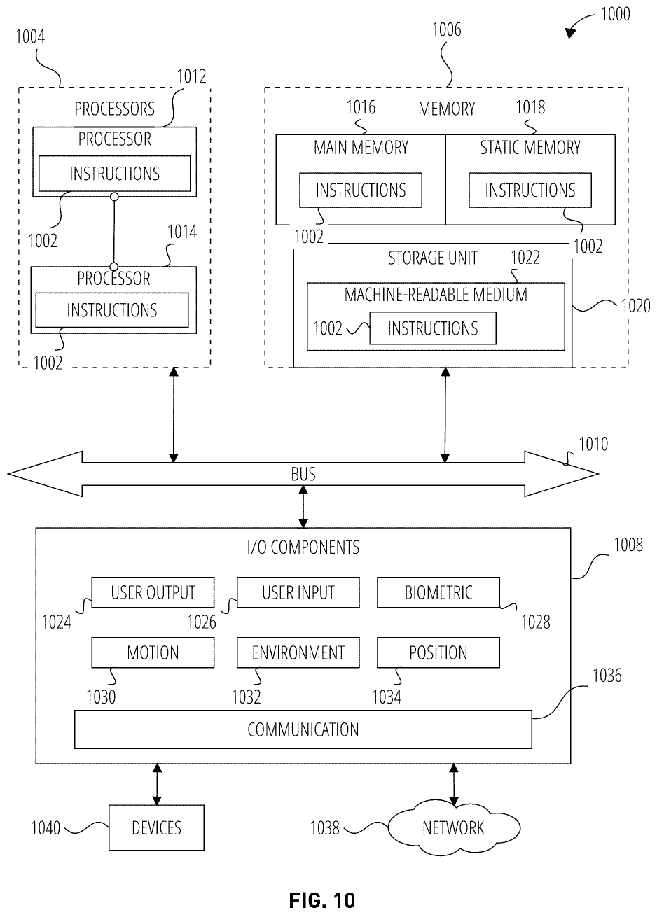

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 (e.g., processor 1012 or processor 1014 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the Processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a Network 1038 or devices 1040 via respective coupling or connections. For example, the communication components 1036 may include a network interface component or another suitable device to interface with the Network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the Processors 1004) and storage unit 1020 may store one or more sets of instructions and data structures (e.g., software) embodying or used by any one or more of the methodologies or functions described herein. These instructions (e.g., the instructions 1002), when executed by Processors 1004, cause various operations to implement the disclosed examples.

The instructions 1002 may be transmitted or received over the Network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

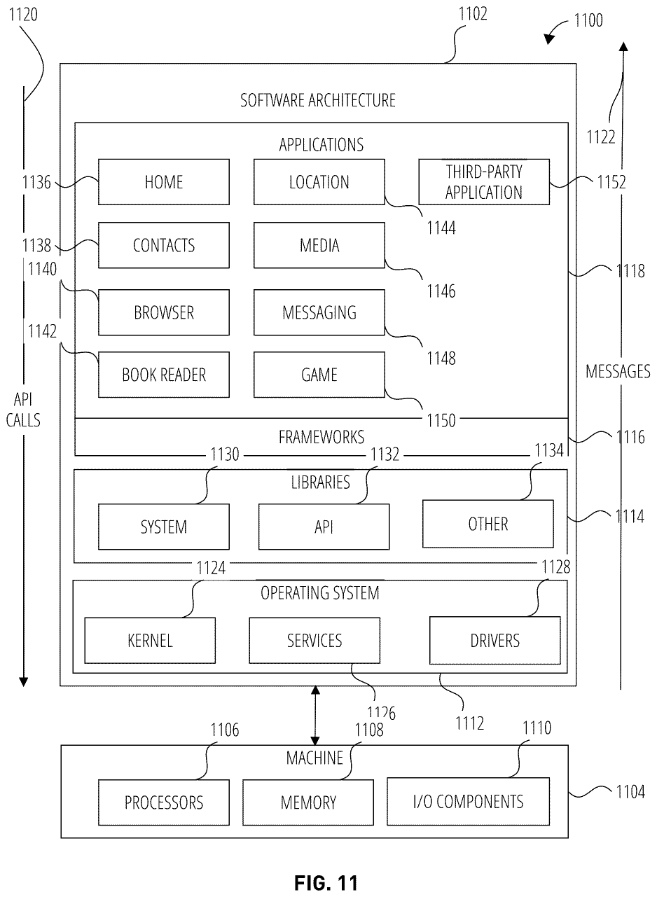

FIG. 11 is a block diagram 1100 illustrating a software architecture 1102, which can be installed on any one or more of the devices described herein. The software architecture 1102 is supported by hardware such as a machine 1104 that includes Processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: accessing a set of instructions that defines a digital effects experience; processing the set of instructions by a generative machine learning model to generate one or more digital effects comprising the digital effects experience; and continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.

Example 2. The system of Example 1, wherein the digital effects experience comprises an augmented reality (AR) or virtual reality (VR) experience.

Example 3. The system of any one of Examples 1-2, wherein the operations comprise: receiving a user selection of the digital effects experience from a list of digital effects experiences; and accessing the set of instructions associated with the digital effects experience in response to receiving the user selection.

Example 4. The system of Example 3, wherein the digital effects experience is a first digital effects experience, and wherein the operations comprise: presenting the list of digital effects experiences comprising the first digital effects experience and a second digital effects experience, the first digital effects experience comprising the set of instructions to be processed by the generative machine learning model in real time, the second digital effects experience comprising code segments processed by a tracking system and three-dimensional (3D) modeling and rendering system of the user device to provide digital effects of the second digital effects experience.

Example 5. The system of Example 4, wherein the operations comprise: presenting a first indicator in association with the first digital effects experience to indicate that the first digital effects experience is generated by the generative machine learning model in real time; and presenting a second indicator in association with the second digital effects experience to indicate that the second digital effects experience is generated by the tracking system and the 3D modeling and rendering system of the user device.

Example 6. The system of any one of Examples 4-5, wherein the first digital effects experience presents, adjusts, and animates the one or more digital effects without using the tracking system and the 3D modeling and rendering system of the user device.

Example 7. The system of any one of Examples 1-6, wherein the operations comprise: accessing a video captured by a camera of the user device, the video depicting a first portion of a real-world environment; processing, by the generative machine learning model, the video with the set of instructions to render a new video comprising the digital effects experience with the one or more digital effects; and presenting the new video as the digital effects experience on the user device.

Example 8. The system of Example 7, wherein the operations comprise: detecting, as the one or more inputs, movement of the user device to capture an image depicting a second portion of the real-world environment; and processing, the image depicting the second portion of the real-world environment along with the set of instructions by the generative machine learning model to generate an additional video as the digital effects experience.

Example 9. The system of any one of Examples 7-8, wherein the operations comprise: detecting, as the one or more inputs, user interaction with the one or more digital effects that are presented in the new video as part of the digital effects experience; and processing, the user interaction along with the set of instructions by the generative machine learning model to generate an additional video as the digital effects experience.

Example 10. The system of Example 9, wherein the one or more inputs comprise one or more audio inputs, one or more image inputs, or one or more physical movement inputs.

Example 11. The system of any one of Examples 1-10, wherein the set of instructions comprise a textual prompt, the textual prompt defining a scene and describing the one or more digital effects, and the textual prompt describing movement of the one or more digital effects and positioning of the one or more digital effects.

Example 12. The system of Example 11, wherein the positioning of the one or more digital effects is described in relation to one or more real-world objects that are depicted in an input image or video.

Example 13. The system of Example 12, wherein the one or more real-world objects comprise a body part of a person depicted in the input image or video.

Example 14. The system of any one of Examples 11-13, wherein the textual prompt defines interactivity of the digital effects experience, the interactivity describing modifications to be made by the generative machine learning model in real time responsive to the one or more inputs received by a user device.

Example 15. The system of any one of Examples 11-14, wherein the textual prompt includes a goal associated with the digital effects experience.

Example 16. The system of any one of Examples 11-15, wherein the textual prompt comprises a digital object that is used as the one or more digital effects, and wherein the textual prompt comprises a set of conditions associated with presentation of the one or more digital effects.

Example 17. The system of any one of Examples 14-16, wherein the digital effects experience is presented on the user device as a video by bypassing one or more graphics processing engines of the user device.

Example 18. The system of any one of Examples 1-17, wherein the generative machine learning model comprises a video render trained to generate video based on a prompt comprising instructions.

Example 19. A computer-implemented method comprising: accessing a set of instructions that defines a digital effects experience; processing the set of instructions by a generative machine learning model to generate one or more digital effects comprising the digital effects experience; and continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.

Example 20. A non-transitory computer-readable storage medium storing instructions that, when executed by at least one processor, cause the at least one processor to perform operations comprising: accessing a set of instructions that defines a digital effects experience; processing the set of instructions by a generative machine learning model to generate one or more digital effects comprising the digital effects experience; and continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors.

Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing a set of instructions that defines a digital effects experience;
processing the set of instructions by a generative machine learning model to generate one or more digital effects comprising the digital effects experience; and
continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.

2. The system of claim 1, wherein the digital effects experience comprises an augmented reality (AR) or virtual reality (VR) experience.

3. The system of claim 1, wherein the operations comprise:
receiving a user selection of the digital effects experience from a list of digital effects experiences; and
accessing the set of instructions associated with the digital effects experience in response to receiving the user selection.

4. The system of claim 3, wherein the digital effects experience is a first digital effects experience, and wherein the operations comprise:
presenting the list of digital effects experiences comprising the first digital effects experience and a second digital effects experience, the first digital effects experience comprising the set of instructions to be processed by the generative machine learning model in real time, the second digital effects experience comprising code segments processed by a tracking system and three-dimensional (3D) modeling and rendering system of the user device to provide digital effects of the second digital effects experience.

5. The system of claim 4, wherein the operations comprise:
presenting a first indicator in association with the first digital effects experience to indicate that the first digital effects experience is generated by the generative machine learning model in real time; and
presenting a second indicator in association with the second digital effects experience to indicate that the second digital effects experience is generated by the tracking system and the 3D modeling and rendering system of the user device.

6. The system of claim 4, wherein the first digital effects experience presents, adjusts, and animates the one or more digital effects without using the tracking system and the 3D modeling and rendering system of the user device.

7. The system of claim 1, wherein the operations comprise:
accessing a video captured by a camera of the user device, the video depicting a first portion of a real-world environment;
processing, by the generative machine learning model, the video with the set of instructions to render a new video comprising the digital effects experience with the one or more digital effects; and
presenting the new video as the digital effects experience on the user device.

8. The system of claim 7, wherein the operations comprise:
detecting, as the one or more inputs, movement of the user device to capture an image depicting a second portion of the real-world environment; and
processing, the image depicting the second portion of the real-world environment along with the set of instructions by the generative machine learning model to generate an additional video as the digital effects experience.

9. The system of claim 7, wherein the operations comprise:
detecting, as the one or more inputs, user interaction with the one or more digital effects that are presented in the new video as part of the digital effects experience; and
processing, the user interaction along with the set of instructions by the generative machine learning model to generate an additional video as the digital effects experience.

10. The system of claim 9, wherein the one or more inputs comprise one or more audio inputs, one or more image inputs, or one or more physical movement inputs.

11. The system of claim 1, wherein the set of instructions comprise a textual prompt, the textual prompt defining a scene and describing the one or more digital effects, and the textual prompt describing movement of the one or more digital effects and positioning of the one or more digital effects.

12. The system of claim 11, wherein the positioning of the one or more digital effects is described in relation to one or more real-world objects that are depicted in an input image or video.

13. The system of claim 12, wherein the one or more real-world objects comprise a body part of a person depicted in the input image or video.

14. The system of claim 11, wherein the textual prompt defines interactivity of the digital effects experience, the interactivity describing modifications to be made by the generative machine learning model in real time responsive to the one or more inputs received by a user device.

15. The system of claim 11, wherein the textual prompt includes a goal associated with the digital effects experience.

16. The system of claim 11, wherein the textual prompt comprises a digital object that is used as the one or more digital effects, and wherein the textual prompt comprises a set of conditions associated with presentation of the one or more digital effects.

17. The system of claim 14, wherein the digital effects experience is presented on the user device as a video by bypassing one or more graphics processing engines of the user device.

18. The system of claim 1, wherein the generative machine learning model comprises a video render trained to generate video based on a prompt comprising instructions.

19. A computer-implemented method comprising:
accessing a set of instructions that defines a digital effects experience;
processing the set of instructions by a generative machine learning model to generate one or more digital effects comprising the digital effects experience; and
continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.

20. A non-transitory computer-readable storage medium storing instructions that, when executed by at least one processor, cause the at least one processor to perform operations comprising:
accessing a set of instructions that defines a digital effects experience;
processing the set of instructions by a generative machine learning model to generate one or more digital effects comprising the digital effects experience; and
continuously processing one or more inputs, received by a user device, while the one or more digital effects comprising the digital effects experience are presented on the user device, along with the set of instructions in real time by the generative machine learning model to update presentation of the one or more digital effects comprising the digital effects experience.
